(19) United States
(12) Patent Application Publication
(10) Pub. No.: US 2023/0333365 A1
(43) Pub. Date: Oct. 19, 2023

(54) MULTI FUNCTION DYNAMIC WINDOW

(71) Applicant: Vasyl Sergan, Carmichael, CA (US)

(72) Inventor: Vasyl Sergan, Carmichael, CA (US)

(21) Appl. No.: 17/688,481

(22) Filed: Mar. 7, 2022

Related U.S. Application Data
(60) Provisional application No. 63/134,134, filed on Jan. 5, 2021.

(51) Int. Cl. G02B 26/00; E06B 3/67; E06B 9/24

(52) U.S. Cl. CPC G02B 26/005; E06B 3/6722; E06B 9/24; E06B 2009/2411; E06B 2009/2417

(57) ABSTRACT

A dynamic window system is generally configured to provide controlled privacy, light intensity, or automation of such features. Glass panes include a treated surface configured to scatter light for privacy generating a default opaque state. Fluids may be controllably dispensed into a cavity. The type of fluid cooperates with the treated surface to change the transmissivity of light through the window. One or more fluids may be used to controls transparency levels. A transparent state of the window may become translucent or darker by introducing another fluid that reduces the transmissivity.

### CROSS-REFERENCE TO RELATED APPLICATIONS

This application claims benefit under 35 U.S.C. § 119(e) of U.S. Provisional Application having Ser. No. 63/134,134 filed on Jan. 5, 2021, which is hereby incorporated by reference herein in its entirety.

### BACKGROUND

The embodiments herein relate generally to windows and more particularly, to a multifunction dynamic window for commercial or residential window and door applications.

Current glass used for windows and doors are static and do not provide dynamic functionality and related advanced features. Double-pane windows may sometimes include a gas in between the panes as insulation to control heat transmission. Typical control of light transmission through glass is provided by layers of film tint applied to outer surfaces of glass. Tinting film is generally static in the amount of light that is allowed to pass through the glass.

### SUMMARY

In one aspect of the subject technology, a dynamic window is provided. The window includes a frame. A first pane is housed in the frame. A second pane is housed in the frame. The first pane and the second pane are arranged to define a cavity. A treated surface is present on one of the first pane or the second pane. A fluid tank is coupled to the frame, for holding a fluid. A port is positioned between the fluid tank and the cavity. A controller is coupled to the fluid tank. The controller is configured to controllably dispense the fluid into the cavity through the port to control a state of transmissivity of light through the first pane and through the second pane.

In one aspect of the subject technology, a dynamic window system is provided. The system includes a double-paned window, including an air-gap between panes. An abraded surface is on the double-paned window. The abraded surface is configured to scatter light passing through the air-gap and generate a default opaque state of the window. A fluid chamber is coupled to the double-paned window and has access to the air-gap. A controller is coupled to the fluid chamber. The controller is configured to dispense one or more fluids into the air-gap to change the double-paned window from the opaque state to a transparent or translucent state.

### BRIEF DESCRIPTION OF THE FIGURES

The detailed description of some embodiments of the invention is made below with reference to the accompanying figures, wherein like numerals represent corresponding parts of the figures.

FIG. 1 is a front view of a dynamic window system in an opaque state according to an embodiment.

FIG. 2 is a cross-sectional side view of the dynamic window system of FIG. 1 with an empty fluid chamber according to an embodiment.

FIG. 3 is a front view of the dynamic window system of FIG. 1 including a section in a transparent state according to an embodiment.

FIG. 4 is a front view of the dynamic window system of FIG. 1 in a fully transparent state according to an embodiment.

FIG. 5 is a cross-sectional side view of the dynamic window system of FIG. 1 with a clear fluid chamber partially filled according to an embodiment.

FIG. 6 is a front view of the dynamic window system of FIG. 3 including the section in a transparent state, tinted according to an embodiment.

FIG. 7 is a front view of the dynamic window system of FIG. 4 in a fully transparent state, with a tinting element according to an embodiment.

FIG. 8 is a cross-sectional side view of the dynamic window system of FIG. 1 with a dye fluid chamber completely filling an internal cavity of the window according to an embodiment.

FIG. 9 is a flowchart of a process for controlling a dynamic transparency of a window according to an embodiment.

### DETAILED DESCRIPTION OF CERTAIN EMBODIMENTS

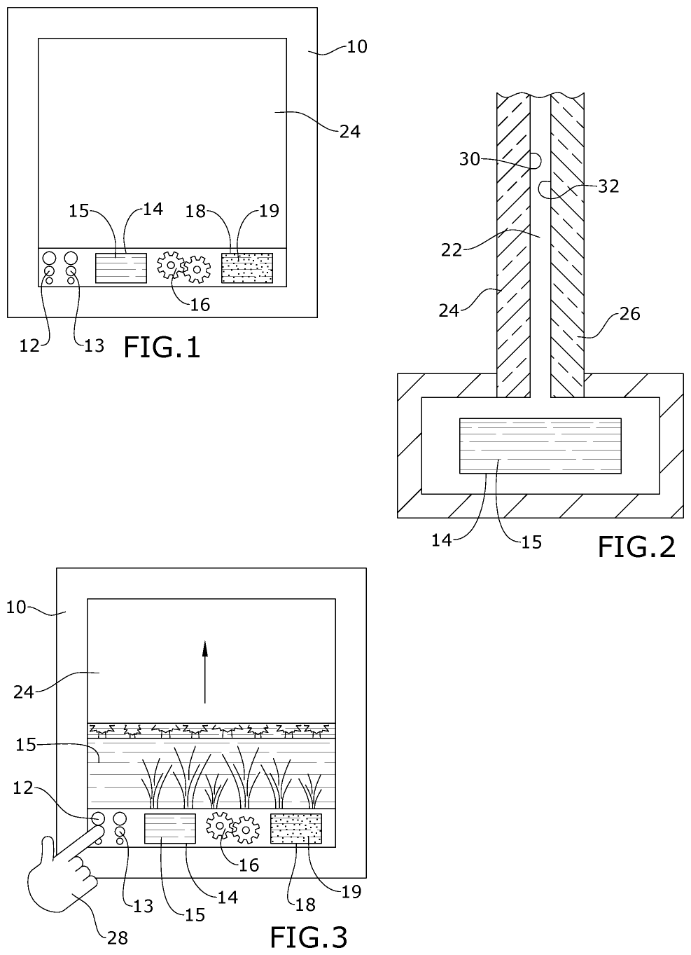

By way of example, and referring to FIGS. 1-8, a dynamic window system (sometimes referred to generally as the “system”) is shown according to an illustrative embodiment. The system is generally configured to provide controlled privacy, light intensity, a level of transparency or automation of such features. The system may be adapted for different scenarios. The applications for the scenarios include, for example, commercial, residential, multi-family living, aviation, marine, and auto industry without any immediate limitations. In simple terms, the product is adaptable anywhere a glass product is usable with minimal or no fenestration and glazing modifications.

In an illustrative embodiment, the dynamic window system 10 may be a double-pane window that includes panes 24 and 26. The panes 24 and 26 may be glass, plastic, polyethylene terephthalate (PET), Polyethylene naphthalate (PEN), or other clear, light transmissive material. The panes 24 and 26 may be separated by a pre-set distance, defining an empty cavity or air-gap 22 there between. The panes 24 and 26 may be transparent. At least one surface of either or both panes 24 and 26 is treated to scatter light. For example, the inner surfaces 30; 32 of one or both pane substrates may be processed to produce a treated surface. One illustrative form of treatment may include for example, roughening or abrasion of a surface. Illustrative embodiments may roughen for example, one or both of inner surfaces 30 and 32. Surfaces 30 and 32 may be the surfaces of respective panes 24;26 that face inward toward the cavity 22. In one embodiment, the treated surface(s) create a default opaque state in the system in the absence of fluid within the cavity 22. FIG. 1 represents an opaque state.

The system may include a fluid chamber coupled to the panes 24 and 26, with access to the cavity 22 through one or more ports. The panes 24 and 26 and the fluid chamber may be housed within a frame 10. The fluid chamber may hold one or more fluid types that are controllably released into the cavity 22 to change the state of transmissivity through the panes 24 and 26.

In an illustrative embodiment, the fluid chamber comprises a first fluid tank 14 and a second fluid tank 18. The fluid tank 14 may store a clear liquid 15. The fluid tank 18 may store a colored fluid 19 (for example, a dye). Introduction of either liquid 15 or 19 changes the state of transmissivity through the panes 24 and 26.

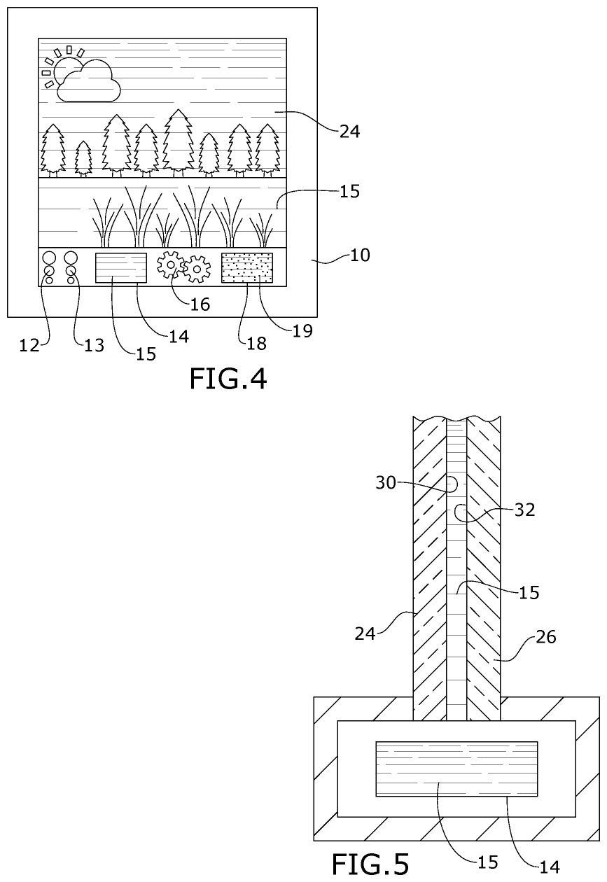

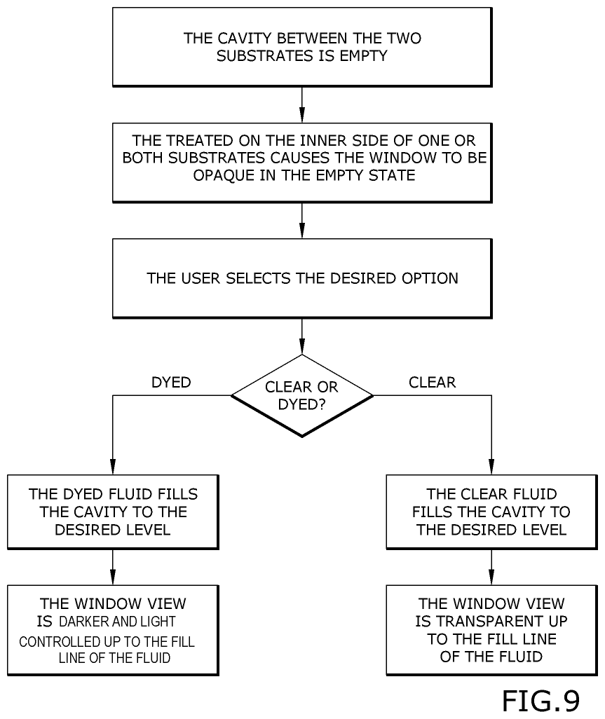

FIGS. 1-8 are described below with concurrent reference to FIG. 9 which discloses an illustrative operation process of the system according to some embodiments. Generally, the system may be operated starting from the default state where the cavity 22 between panes 24 and 26 is empty. In one illustrative example, supplying the clear liquid 15 into the cavity 22 causes changes to how light is scattered as the light passes through the panes 24 and 26. The clear liquid cooperates with the treated surface to minimize scattering since the liquid optically “fills” in the micro refractive surfaces. The system transforms from the opaque state to a transparent state. FIG. 3 represents a bottom section of the system becoming transparent where the level of liquid 15 has risen up into the cavity 22. FIGS. 4 and 5 shows the liquid 15 rising within the cavity 22 filling up the entire viewable area inside the frame 10 so that the panes 24 and 26 become transparent.

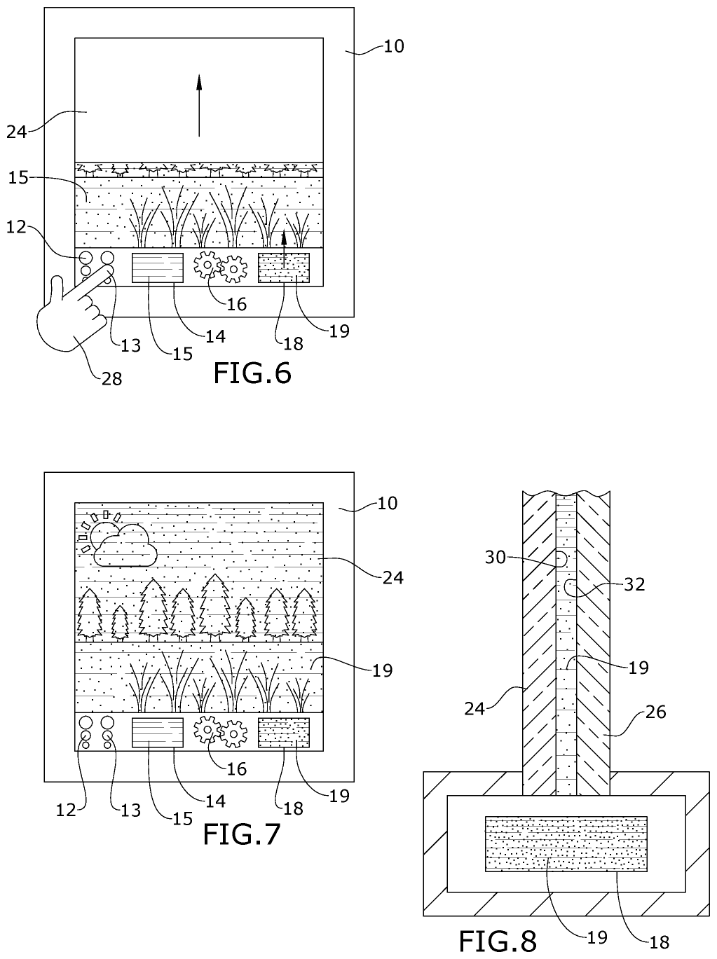

Supplying the dye 19 may also change the state of transmissivity through the panes 24 and 26. In one illustrative embodiment, the dye 19 may be supplied into the cavity 22 after the clear liquid 15 has been introduced to control the light intensity passing through the system. The dye 19 may change the state of transmission from transparent to translucent allowing some light to pass through while keeping the background visible but at a less intense level. FIG. 6 shows a bottom section of the viewable area that has previously been filled with clear liquid 15 in a state that is receiving dye 19 as well. The bottom section has become less than transparent but not opaque. The top section remains opaque since neither fluid type has made contact with the treated sections of the panes 24 and 26 at the upper levels of the system. FIGS. 7 and 8 show the dye 19 rising up the cavity 22 to fil the entire viewable area of the system shading out some of the light passing through the panes 24 and 26.

Some embodiments include an operating system to controllably dispense the fluids into the cavity 22 to provide different heights of coverage within the cavity 22 at different levels of transparency or privacy. The user may for example, select from a fill selection panel which controls the different levels of fill and transparency. In one illustrative example, the system includes a control panel 12 controlling the amount of clear liquid 15 that is dispensed into the cavity 22. A control panel 13 may control how high up the cavity 22 the dye 19 is dispensed. Also, the amount of dye 19 that is dispensed may control the level of translucence/light blocking desired by a user. Hardware 16, for example a pump or other dispensing device, may be operated according to the settings entered into control panels 12 and 13.

The window in its natural or default state provides privacy because the treated surface(s) scatters light on impact. Because of proper wetting characteristics (microscopic-touch) between the treated surfaces and the choice of liquid 15 or 19, the window looks transparent.

As will be appreciated, several features of the illustrative embodiments provide user control over how much light passes through the window as well as control over the area of window letting light pass through. The fluid introduction elements control when a user wants to switch from an opaque setting (that provide privacy as a default state) to a transparent state so that the other side of the window becomes visible. The height control allows the user to determine how much of the viewable area can be seen, replicating the function of blinds. The second fluid provides the user with fine tune control over how much light passes through so that for example, if the day is very bright, the outside can be seen at whatever comfortable level of light passing through is desired by the user.

Persons of ordinary skill in the art may appreciate that numerous design configurations may be possible to enjoy the functional benefits of the inventive systems. For example, while the operating system is shown on the bottom extremity of the window system frame and the dispensing ports are shown dispensing fluid from the bottom, it should be understood that the fluids may be dispensed from different locations around the cavity 22. In some embodiments, the surface treatment may be modified, and yet other elements of the system may also be modified to provide the same effects. for example, in some embodiments, the panes 24 and 26 may be selected as transparent by nature (which unlike the above embodiment provides no privacy in a default state). The selection of the fluid types may then be opaque instead of clear. In which case, the window needs to be filled with the opaque fluid to provide a privacy setting to the user. The principle is reversed in this example but there are several advantages in the current embodiment, too. In another embodiment, the selection of fluid may provide an open a broad range of applications to the entire window and door industry. With a highly efficient fluid management system, the system could use various fluids based on day, night, season, weather, and the interests of the consumer.

Thus, given the wide variety of configurations and arrangements of embodiments of the present invention the scope of the invention is reflected by the breadth of the claims below rather than narrowed by the embodiments described above.

What is claimed is:

1. A dynamic window, comprising:
a frame;
a first pane housed in the frame;
a second pane housed in the frame, wherein the first pane and the second pane are arranged to define a cavity between the first pane and the second pane;
a treated surface on one of at least the first pane or the second pane;
a fluid tank coupled to the frame, for holding a fluid;
a port positioned between the fluid tank and the cavity; and
a controller coupled to the fluid tank, wherein the controller is configured to controllably dispense the fluid into the cavity through the port to control a state of transmissivity of light through the first pane and through the second pane.

2. The dynamic window of claim 1, wherein the treated surface is a roughened surface.

3. The dynamic window of claim 1, wherein the treated surface is on an inner surface of either the first pane or the second pane, and is facing inward toward the cavity.

4. The dynamic window of claim 1, wherein the treated surface is configured to provide a default opaque state in an absence of fluid in the cavity.

5. The dynamic window of claim 1, wherein the fluid includes a clear fluid, and a presence of the clear fluid in the cavity generates a transparent condition through the first pane and through the second pane.

6. The dynamic window of claim 1, wherein the fluid includes a dyed fluid, and a presence of the dyed fluid in the cavity changes the state of transmissivity from an opaque state to a translucent.

7. The dynamic window of claim 1, wherein the fluid tank comprises:
a first chamber and a clear liquid in the first chamber,
a second chamber and a dyed liquid in the second chamber, wherein:
a dispense of the clear liquid into the cavity transforms the state of transmissivity from a default opaque state to a transparent state, and
a dispense of the dyed liquid into the cavity changes the state of transmissivity from the transparent state to a translucent state.

8. A dynamic window system, comprising:
a double-paned window, including an air-gap between panes;
an abraded surface on the double-paned window, wherein the abraded surface is configured to scatter light passing through the air-gap and generating a default opaque state of the window;
a fluid chamber coupled to the double-paned window and having access to the air-gap; and
a controller coupled to the fluid chamber, wherein the controller is configured to dispense one or more fluids into the air-gap to change the double-paned window from the opaque state to a transparent or translucent state.

9. The dynamic window system of claim 8, wherein a first fluid is a clear fluid and a second fluid is a dye.

10. The dynamic window system of claim 9, wherein:
in response to the clear fluid being in the air-gap, the double-paned window changes from the opaque state to a transparent state, and
in response to the dye being in the air-gap simultaneously with the clear fluid, the double-paned window changes from the transparent state to the translucent state.
